(19) United States
(12) Patent Application Publication
(10) Pub. No.: US 2026/0274710 A1
(43) Pub. Date: Sep. 17, 2026

(54) ULTRAPURE WATER PROCESSING SYSTEM WITH WATER HAMMER SHOCK MITIGATION FUNCTION

(71) Applicant: Flowtech Co., Ltd., Incheon (KR)

(72) Inventor: Jae Gu YANG, Incheon (KR)

(21) Appl. No.: 19/078,503

(22) Filed: Mar. 13, 2025

(51) Int. Cl. C02F 1/00; C02F 1/20; C02F 103/04

(52) U.S. Cl. CPC C02F 1/006; C02F 1/20; C02F 2103/04; C02F 2201/005; C02F 2301/063

(57) ABSTRACT

An ultrapure water (UPW) processing system for producing ultrapure water by sequentially transferring treated water along a main pipeline between a pretreatment process, a pure water treatment process, and an ultrapure water treatment process, the UPW processing system includes: a surge tank for preventing water shock directly connected to the main pipeline through which the treated water is transported, wherein the surge tank is configured to enable first-in, first-out selection of the treated water flowing into the surge tank by receiving treated water connected to the main pipeline at an upper end of the surge tank and discharging treated water connected to the main pipeline at a lower end of the surge tank.

### BACKGROUND

### Field

Embodiments of the invention relate generally to an ultrapure water (UPW) processing system, and more particularly, to UPW processing system having a water hammer shock mitigation function.

### Discussion of the Background

Ultrapure water (UPW) is a critical high-purity water source essential in various industries, including semiconductor manufacturing, pharmaceutical production, and power generation. A typical UPW production process, as depicted in FIG. 1, generally comprises a pretreatment stage (20), a pure water treatment stage (30), and a UPW treatment stage (50). The pretreatment stage (20) is designed to enhance the quality of the source water (10) (e.g., from a municipal water treatment plant) and to improve the efficiency of subsequent processes. This stage typically involves processes such as coagulation, sedimentation, and filtration to remove suspended solids, organic materials, and colloids from the raw water. The pure water treatment stage (30) focuses on removing ionic species from the pretreated water. This stage commonly utilizes reverse osmosis (RO) systems and ion exchange resins. RO significantly reduces the electrical conductivity of the water and removes a majority of dissolved solids. The water existing the pure water treatment stage (30) is temporarily stored in a pure water storage tank (40) before being fed to the UPW treatment stage (50). The UPW treatment stage (50) further polishes the purified water to produce UPW, employing technologies such as mixed-bed ion exchange resin towers, electrodeionization (EDI) units, and ultraviolet (UV) sterilizers. This stage removes residual ions, organic compounds, and microorganisms to meet stringent UPW quality standards. The resulting UPW from the UPW treatment stage (50) is then supplied to the end user (60).

In these UPW production systems, the various treatment stages are sequentially connected along a main piping system. Water hammer can occur within the piping due to valve actuation or pump operation (start/stop) at the different process units. Water hammer is a pressure surge or wave caused by a sudden change in fluid velocity. It can cause significant damage to the piping system and degrade the performance of the water treatment equipment. For example, in EDI units (which remove contaminants by adsorption onto resin), water hammer can disrupt the resin bed, causing uneven distribution of the resin and leading to reduced contaminant removal or resin damage, resulting in degraded water quality. Similarly, in RO units, water hammer can cause accumulated contaminants on the membrane to be forced through the membrane, or even damage the membrane itself, leading to a decline in water quality. Therefore, mitigating water hammer is crucial for maintaining the integrity and performance of most water treatment equipment. Traditional water treatment systems often use surge tanks to mitigate water hammer. A surge tank, as illustrated in FIG. 2(a), is a vessel designed to absorb pressure surges in a piping system. It is connected to a branch pipe (2) off of the main pipe (1). The upper portion of the surge tank contains compressed air, which serves as the primary cushioning medium. When a water hammer occurs, the compressed air compresses in response to the pressure surge, absorbing the energy of the surge. The air then gradually expands, providing a more stable pressure to the system. This process helps to maintain the piping pressure within a safe range, reducing or preventing damage caused by rapid pressure fluctuations.

However, conventional surge tank configurations, such as that shown in FIG. 2(a), suffer from a critical drawback in UPW systems. Because the main pipe (1) is connected to the surge tank via a single branch pipe (2), water enters and exits the surge tank only through this single connection (as indicated by the dotted arrows). This can lead to stagnation of water within the surge tank, causing a deterioration of water quality inside the tank. In UPW systems, even slight changes in operating pressure from the pumps are unacceptable. For this reason, traditional surge tanks are not installed on the pump outlet side, as any water stored inside a standard surge tank is prone to stagnate. Stagnation can lead to unacceptable degradation of the UPW. For example, if UPW production exceeds UPW consumption, the excess UPW is diverted to a holding tank in the initial treatment phase in order to avoid water stagnation. Therefore, conventional surge tanks have generally been unsuitable for UPW systems due to the potential for water quality degradation. Maintaining the extreme purity of UPW requires constant circulation and flow to minimize the risk of microbial growth, contaminant buildup, or changes in electrical conductivity.

Therefore, there exists a need for a new water hammer mitigation system that addresses the specific requirements of UPW systems while effectively mitigating pressure surges.

The above information disclosed in this Background section is only for understanding of the background of the inventive concepts, and, therefore, it may contain information that does not constitute prior art.

### SUMMARY

The present invention addresses the problems associated with water hammer in conventional UPW production processes. The objective of this invention is to provide a novel UPW system that effectively mitigates water hammer using a surge tank without compromising the quality of the UPW.

Additional features of the inventive concepts will be set forth in the description which follows, and in part will be apparent from the description, or may be learned by practice of the inventive concepts.

According to one or more embodiments of the invention, an ultrapure water (UPW) processing system for producing ultrapure water by sequentially transferring treated water along a main pipeline between a pretreatment process, a pure water treatment process, and an ultrapure water treatment process, the UPW processing system includes: a surge tank for preventing water shock directly connected to the main pipeline through which the treated water is transported, wherein the surge tank is configured to enable first-in, first-out selection of the treated water flowing into the surge tank by receiving treated water connected to the main pipeline at an upper end of the surge tank and discharging treated water connected to the main pipeline at a lower end of the surge tank.

The system may further include: an inlet connected to the main pipeline at an upper end of the surge tank to receive treated water, and an outlet connected to the main pipeline at a lower end of the surge tank to discharge treated water.

The system may further include: a conduit extending laterally of the surge tank, connected at one end to the inlet and extending at the other end to the interior of said surge tank, so that the treated water is moved downwardly in a spiraling rotation and discharged toward the outlet.

The system may further include: a pure water storage tank for receiving and temporarily storing treated water from the pure water treatment process and for degassing to remove dissolved gases contained in the treated water.

The pure water storage tank may include: a pressure tank; a vacuum pump connected with an upper end of the pressure tank for creating a vacuum inside the pure water storage tank; a filling pipe connected to an outlet side of the pressure pump for filling the pure water storage tank with treated water after a vacuum is created inside the pure water storage tank by the vacuum pump; an exhaust valve connected to the upper end of the pressure tank for discharging gas remaining in the pressure tank to the outside when the pure water storage tank is filled with treated water; and a gas supply for pressurized filling of the pressure tank with insoluble gas is connected to the upper other side of the pressure tank.

The system may further include: an auxiliary storage tank on one side of the pure water storage tank, wherein the auxiliary storage tank is connected to the vacuum pump at its upper end, an exhaust valve and a gas feeder are respectively connected to its upper other end, a lower end is connected to the main pipeline, and a filling pipe connected to the outlet side of the vacuum pump is connected to said lower other end for filling the treated water inside the auxiliary storage tank after a vacuum is formed inside the auxiliary storage tank by the vacuum pump.

According to the present invention as described above, by adopting a direct-connected surge tank capable of first-in, first-out treatment water, water shock can be alleviated while preventing stagnation of treatment water, thereby maintaining the quality of ultrapure water.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention, and together with the description serve to explain the inventive concepts.

FIG. 1 is a schematic diagram of a conventional ultrapure water process system.

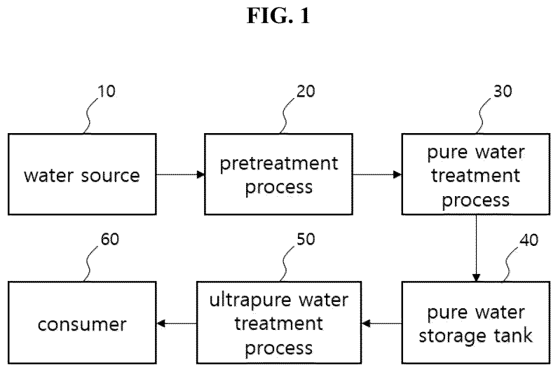

FIG. 2 is a diagram comparing the connection structure of a conventional surge tank for water hammer prevention (a) with the connection structure of the surge tank according to the present invention (b).

FIG. 3 is a schematic diagram of a UPW process system equipped with a surge tank according to a preferred embodiment of the invention.

FIG. 4 is a schematic diagram of a UPW process system equipped with a surge tank and a pure water storage tank according to another preferred embodiment of the invention.

FIG. 5 is a detailed configuration diagram of a surge tank according to a preferred embodiment of the invention.

FIG. 6 is a diagram illustrating the degassing operation of a pure water storage tank used in a UPW process system according to the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, the configuration and operation of an ultrapure water process system having a water shock mitigation function according to the present invention will be described in detail with reference to the attached drawings and preferred embodiments.

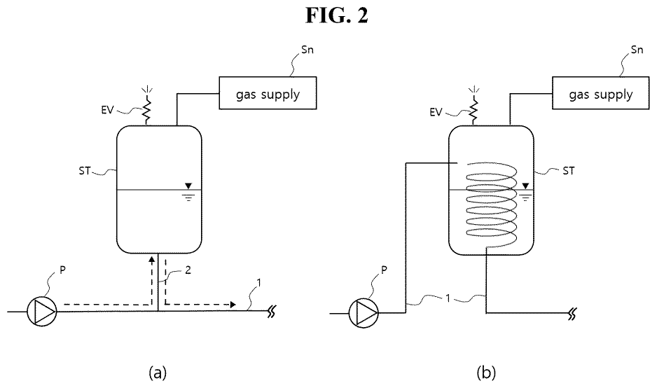

FIG. 2 is a diagram comparing the connection structure of a conventional surge tank for water hammer prevention (a) with the connection structure of the surge tank according to the present invention (b). The surge tank (130) is a pressure tank for preventing water hammer occurring in an ultrapure water process, and like a general surge tank for preventing water hammer, a gas supply device (Sn) and an exhaust valve (EV) are provided at the top, so that compressed gas such as compressed air or nitrogen is filled inside the surge tank. It is configured so that the internal water level is kept constant by the method of discharge. The configuration and operation of such a general surge tank are already known, so further detailed description is omitted.

As mentioned above and in FIG. 2 As shown in (a), a typical surge tank is connected to the main pipe (1) by a single branch pipe (2), but the surge tank (130) according to the present invention is a first-in, first-out type surge tank directly connected to the main pipe (1). More specifically, the surge tank (130) employed in the ultrapure water process system according to the present invention is shown in FIG. 2. (b) As shown in, it is directly connected to the main pipe (1), but on the upper side of the surge tank (130). An inlet for introducing treated water connected to the main pipe (1) is provided, and an outlet for discharging treated water is provided at the bottom of the surge tank (130) connected to the main pipe, so that treated water introduced directly into the main pipe is transported in one direction, enabling first-in, first-out treatment of treated water introduced into the surge tank (130). Accordingly, treated water does not stagnate inside the surge tank (130), thereby solving the problem of water quality deterioration.

A direct-connected first-in, first-out surge tank (130) like this can be installed anywhere in the main pipe (1) of the ultrapure water process. That is, the direct-connected first-in, first-out surge tank (130) can be installed between the pure water treatment process (30) and the ultrapure water treatment process (50), and can be installed anywhere in the main pipe (1) connecting individual units constituting the ultrapure water treatment process (50) (e.g., heat exchanger, UV oxidation device, anion polisher, mixed-bed polisher, membrane degassing device, ultrafiltration device, etc.).

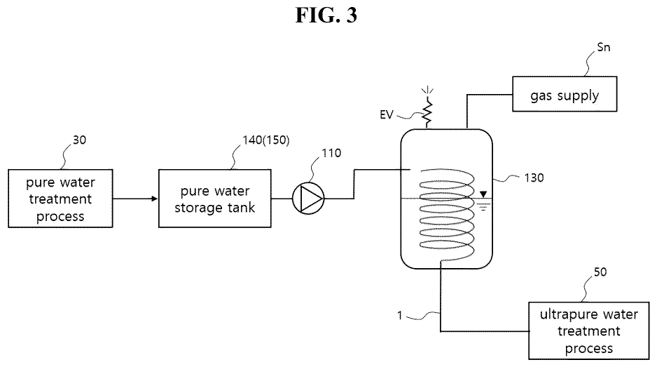

FIG. 3 illustrates a configuration diagram of an ultrapure water process system in which a direct-connected first-in, first-out surge tank (130) is installed between a pure water treatment process (30) and an ultrapure water treatment process (50) as a preferred embodiment according to the present invention. As illustrated, a pure water storage tank (140, 150) in which manufactured pure water is temporarily stored is provided at the rear end of the pure water treatment process (30), and a pressurizing pump (110) and a surge tank (130) may be installed between the pure water storage tank (140, 150) and the ultrapure water treatment process (50).

The above pressurized pump (110) is a pump that connects each treatment stage of the ultrapure water process and is installed in the main pipe through which the treated water is transported to pressurize and transport the treated water. By this pressurized pump (110), the treated water is pressurized and transported along the main pipe to the upper side of the surge tank (130). After being introduced, it is discharged back into the main pipe from the bottom.

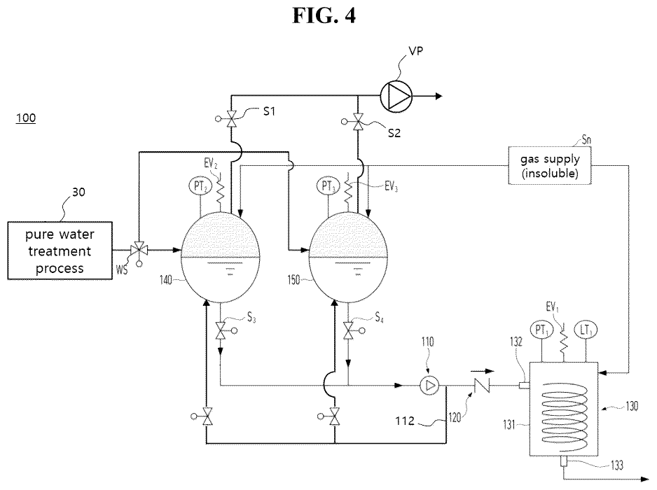

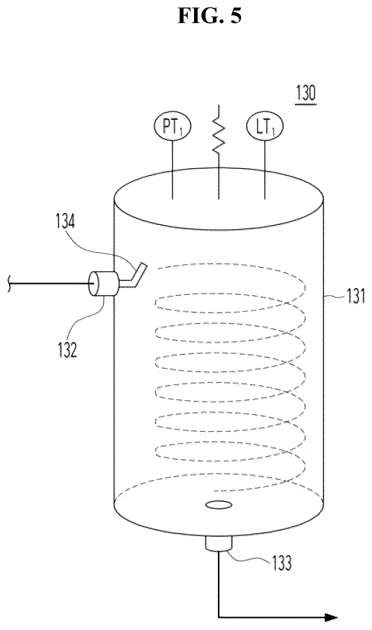

The structure of the surge tank (130) is illustrated in more detail in FIGS. 4 and 5. As illustrated, the surge tank (130) includes a tank body (131) having a space for receiving treated water therein, an inlet (132) provided at an upper end of the tank body (131) for receiving the treated water, a discharge port (133) provided at a lower end of the tank body (131) for discharging the treated water, and an induction pipe (134) extending laterally of the tank body (131) such that one end is connected to the inlet port (132) and the other end extends into the interior of the tank body (131) so that the treated water moves downward while rotating in a spiral shape and is discharged toward the discharge port (133). In addition, a pressure sensor (PT₁) and a level sensor (LT₁) for detecting internal pressure and level, and an exhaust valve (EV₁) for discharging internal gas to the outside are provided at the upper portion of the surge tank (130). In addition, a gas supplier (Sn), such as a compressor, nitrogen generator, or nitrogen bomb, for supplying compressed gas to the inside is connected to one side of the upper portion of the surge tank (130).

Meanwhile, as previously mentioned, the inside of the surge tank (130) is filled with compressed gas, and the compressed gas may be compressed air or nitrogen, etc. Pressure changes frequently occur inside the surge tank (130), and such pressure changes may cause gas to dissolve in water. When compressed air is used, dissolved oxygen or carbon dioxide increases, and since dissolved gas increases the conductivity of water and ultrapure water requires very low conductivity, the presence of dissolved gas deteriorates the quality of ultrapure water. In addition, when the dissolved oxygen concentration increases, it becomes difficult to control the gate oxide thickness during semiconductor wafer processing, has a negative effect on the continuous electroionization (EDI) process, and may promote microbial growth, resulting in contamination of the ultrapure water system. In order to minimize such dissolved gas, the ultrapure water process system according to the present invention includes a pure water storage tank (140).

The above pure water storage tank (140) is a tank that temporarily stores the treated water supplied from the pure water treatment process (30). In the past, it was a storage tank in the form of a general metal tank, but in the present invention, it is a low-pressure storage tank, but it is not easily distorted or damaged by pressure changes, and as described later, it is preferably configured as a pressure tank so as to prevent deformation during vacuum depressurization for internal degassing.

The above pure water storage tank (140) has a degassing function as mentioned above. For this purpose, a treated water supply valve (WS), a vacuum pump (VP), a water charging pipe (112), an exhaust valve (EV₂), and a gas supply (Sn) are connected to the above pure water storage tank (140), as shown in FIG. 4.

It is preferable that the treated water supply valve (WS) be an electric valve installed in the main pipe connected to the pure water treatment process (30) to control the supply of treated water to the pure water storage tank (140). Here, the treated water supply valve (WS) is configured as a general 2-WAY valve when the pure water storage tank (140) is configured as a single tank, and as described below, it is preferable that it is configured as a 3-WAY valve when the pure water storage tank (140, 150) is configured as a plurality of tanks.

A vacuum pump (VP) discharges the remaining gas contained in the pure storage tank (140) for a set period of time or longer to the outside and forms a vacuum of approximately −1 bar inside the pure storage tank (140). The vacuum pump (VP) is provided outside the pure storage tank (140) and is connected to the upper side of the pure storage tank (140) by a pipe, and a first suction cut-off valve (S₁) is installed in this connecting pipe.

The water filling pipe (112) is a pipe that connects the outlet side of the pressurized pump and the lower part of the pure water storage tank to refill the pure water storage tank with treated water after a vacuum is formed inside the pure water storage tank by the vacuum pump. It is natural that a separate valve (not given a drawing symbol) is installed in the water filling pipe (112).

The exhaust valve (EV₂) is a valve that discharges the gas remaining in the pure water storage tank (140) to the outside when the pure water storage tank (140) is filled with treated water by the treated water supply valve (WS).

The gas supplier (Sn) injects an insoluble seal gas at high pressure into the interior of the pure water storage tank (140). The gas supplier (Sn) that supplies compressed gas to the surge tank (130) may be commonly used, or a separate, independent gas supplier (Sn) may be used. The compressed gas supplied from the gas supplier (Sn) to the pure water storage tank (140) pressurizes the treated water filled in the pure water storage tank (140) and discharges it through the main pipe connected to the lower portion. Here, the lower main pipe of the pure water storage tank (140) is provided with a first discharge control valve (S3) for controlling the discharge of the treated water.

Already mentioned above and illustrated in FIG. 4, the pure water storage tank (140) may be composed of a plurality of tanks. That is, an auxiliary storage tank (150) may be additionally provided on one side of the pure water storage tank (140). The auxiliary storage tank (150) is composed of the same structure as the pure water storage tank (140). Specifically, the auxiliary storage tank (150) has a lower side connected to a vacuum pump (VP) by a pipe, and a second suction shut-off valve (S2) is provided in the pipe, an upper side connected to the treated water supply valve (WS) by a separate supply pipe, the lower other side connected to the main pipe through a separate discharge pipe, and a second discharge shut-off valve (S4) is provided in the discharge pipe, an exhaust valve (EV₃) is provided on the upper side, and a gas supply device (Sn) is connected to the other side. In this way, when the pure storage tank (140) and the auxiliary storage tank (150) are connected in parallel, the degassing and supply operations of the treated water can be performed alternately in the two tanks, enabling constant operation of the system without a separate waiting time.

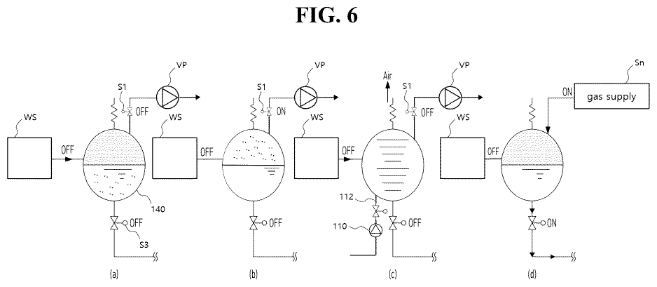

Hereinafter, the degassing and supply method of the treated water in the pure storage tank (140) will be described in more detail with reference to FIG. 6. FIG. 6 is a diagram illustrating the degassing operation of a pure water storage tank used in a UPW process system according to the invention.

FIG. 6 as shown in (a), the lower part of the initial pure water storage tank (140) is filled with pure treated water and the upper part is filled with gas, and dissolved gas remains in the pure treated water. Here, the treated water supply valve (WS), the first suction shut-off valve (S₁), and the first discharge shut-off valve (S₃) are in the closed (OFF) state. In this state, for degassing, as shown in FIG. 6 As shown in (b), the first suction-disconnecting valve (S₁) is opened (ON) and the vacuum pump (VP) is operated so that all gases contained inside the pure water storage tank (140) or remaining in the treated water are discharged to the outside. After the residual gas is discharged, the vacuum pump (VP) continues to operate until the pressure inside the pure water storage tank (140) becomes −1 bar, so that a vacuum is formed inside the pure water storage tank (140). Since the pure water storage tank (140) is a pressure tank, it does not shrink or deform even if the pressure drops to −1 bar. In this way, the residual gas inside the pure water storage tank (140) is removed by suction and vacuum treatment of the gas inside the pure water storage tank (140). When the inside of the pure water storage tank (140) becomes a vacuum, as shown in FIG. 6, As shown in (c), the vacuum pump (VP) is stopped, the first suction-stop valve (S₁) is closed (OFF), and the treated water is filled into the pure water storage tank (140) through the charging pipe (112) according to the operation of the pressurizing pump (110). Since the outlet pressure of the pressurizing pump (110) is much higher than that of the low-pressure pure water storage tank (140, 150), filling is accomplished by opening only the valve of the charging pipe (112). At this time, the treated water is buffered inside the pure water storage tank (140), and if a small amount of oxygen remains inside the pure water storage tank (140), the exhaust valve (EV₂) is opened to discharge it to the outside. Accordingly, almost no gas remains inside the pure water storage tank (140). When the treated water is buffered in the pure water storage tank (140), as shown in FIG. 5, As shown in (d), the gas supply (Sn) is turned on (ON), insoluble compressed nitrogen gas is supplied to the upper part of the pure storage tank (140), and when the first discharge control valve (S₃) provided at the lower part of the pure storage tank (140) is opened (ON), the treated water inside the pure storage tank (140) is pressurized by the pressure of the compressed nitrogen. It is discharged through the main pipe. The treated water discharged through the main pipe is pressurized again in the pressure pump (110), passes through the surge tank (130), and is supplied to the ultrapure water treatment process (50).

Meanwhile, since it takes a considerable amount of time until the treated water buffered in the pure storage tank (140) is completely discharged, during this time, the same degassing operation is performed in the auxiliary storage tank (150), and after the treated water in the pure storage tank (140) is completely discharged, the treated water buffered after degassing in the auxiliary storage tank (150) is supplied to the main pipe. While the treated water in the auxiliary storage tank (150) is discharged, degassing is performed again in the pure storage tank (140), and by these alternate degassing and treated water supply operations of the pure storage tank (140) and the auxiliary storage tank (150), the ultrapure water process system can be operated continuously without waiting time.

The above has been described with respect to specific embodiments of the present invention. However, the spirit and scope of the present invention is not limited to these specific embodiments, and those skilled in the art will understand that various modifications and changes can be made without changing the gist of the present invention. Therefore, the embodiments described above are provided to fully inform those skilled in the art of the present invention of the scope of the invention and therefore should be understood to be illustrative and not restrictive in all respects, and the present invention is defined only by the scope of the claims.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An ultrapure water (UPW) processing system for producing ultrapure water by sequentially transferring treated water along a main pipeline between a pretreatment process, a pure water treatment process, and an ultrapure water treatment process, the UPW processing system comprising:
a surge tank for preventing water shock directly connected to the main pipeline through which the treated water is transported,
wherein the surge tank is configured to enable first-in, first-out selection of the treated water flowing into the surge tank by receiving treated water connected to the main pipeline at an upper end of the surge tank and discharging treated water connected to the main pipeline at a lower end of the surge tank.

2. The UPW processing system of claim 1, further comprising:
an inlet connected to the main pipeline at an upper end of the surge tank to receive treated water, and
an outlet connected to the main pipeline at a lower end of the surge tank to discharge treated water.

3. The UPW processing system of claim 2, further comprising:
a conduit extending laterally of the surge tank, connected at one end to the inlet and extending at the other end to the interior of said surge tank, so that the treated water is moved downwardly in a spiraling rotation and discharged toward the outlet.

4. The UPW processing system of claim 2, further comprising:
a pure water storage tank for receiving and temporarily storing treated water from the pure water treatment process and for degassing to remove dissolved gases contained in the treated water.

5. The UPW processing system of claim 4, wherein the pure water storage tank comprises:
a pressure tank;
a vacuum pump connected with an upper end of the pressure tank for creating a vacuum inside the pure water storage tank;
a filling pipe connected to an outlet side of the pressure pump for filling the pure water storage tank with treated water after a vacuum is created inside the pure water storage tank by the vacuum pump;
an exhaust valve connected to the upper end of the pressure tank for discharging gas remaining in the pressure tank to the outside when the pure water storage tank is filled with treated water;
a gas supply for pressurized filling of the pressure tank with insoluble gas is connected to the upper other side of the pressure tank.

6. The UPW processing system of claim 4, further comprising:
an auxiliary storage tank on one side of the pure water storage tank,
wherein the auxiliary storage tank is connected to the vacuum pump at its upper end, an exhaust valve and a gas feeder are respectively connected to its upper other end, a lower end is connected to the main pipeline, and a filling pipe connected to the outlet side of the vacuum pump is connected to said lower other end for filling the treated water inside the auxiliary storage tank after a vacuum is formed inside the auxiliary storage tank by the vacuum pump.
